(19) United States
(12) Patent Application Publication
(10) Pub. No.: US 2020/0215379 A1
(43) Pub. Date: Jul. 9, 2020

(54) TURF-COVERED WORKOUT MAT

(71) Applicant: JENIFER STRYSKA, FARMINGDALE, NY (US)

(72) Inventor: JENIFER STRYSKA, FARMINGDALE, NY (US)

(21) Appl. No.: 16/737,640

(22) Filed: Jan. 8, 2020

Related U.S. Application Data
(60) Provisional application No. 62/790,455, filed on Jan. 9, 2019.

(51) Int. Cl. A63B 21/00; B32B 3/26; B32B 7/09; B32B 7/12

(52) U.S. Cl. CPC A63B 21/4037; B32B 3/263; E01C 13/08; B32B 7/12; A63B 2210/50; B32B 7/09

(57) ABSTRACT

A portable workout mat includes a padding layer and a second layer attached to the padding layer. The padding layer includes a first padding material. The second layer includes synthetic turf. The portable workout mat is a strip configured to be rolled out or unfolded for a workout with either the padding layer facing upward or the second layer facing upward. The strip is rolled up or folded up for removal and transport after completion of the workout. For a workout method, a portable workout mat is provided. The portable workout mat is unfolded or unrolled onto a floor so that the portable workout mat has a full extension and with the synthetic turf facing upward. A workout routine is performed with at least one glider sliding on the synthetic turf. The portable workout mat is rolled up or folded up for transport after completion of the workout routine.

### CROSS REFERENCE TO RELATED APPLICATIONS

Applicant claims priority under 35 U.S.C. 119(e) of U.S. Provisional Patent Application Ser. No. 62/790,455 filed Jan. 9, 2019, the disclosure of which is incorporated by reference.

### BACKGROUND OF THE INVENTION

### 1. Field of the Invention

This invention relates to a yoga mat.

### 2. The Prior Art

Yoga mats are commonly used by individuals in modern society to help practice yoga and conduct exercise and stretching. Individuals own their own yoga mat for use at home or carry the mat with them to the gym or other area or location for yoga exercise. The known mat largely or exclusively consists of a padding layer that has a uniform consistency and composition throughout the workout mat.

Gliders are also commonly used for workouts. An individual places his hands or feet in a glider, and the glider glides along a carpet surface and can perform a variety of workout routines.

### SUMMARY OF THE INVENTION

A portable workout mat is provided that includes a padding layer and a second layer attached to the padding layer. The padding layer includes a first padding material. The second layer includes synthetic turf. The portable workout mat is a strip configured to be rolled out or unfolded for a workout by an individual exerciser with either the padding layer facing upward or the second layer facing upward. The strip is configured to be rolled up or folded up for removal and transport after completion of the workout.

Further, a workout kit is provided that includes the portable workout mat as well as at least one glider. The glider has a gliding surface and is configured to hold a foot or a hand and configured to slide along the synthetic turf of the portable workout mat.

A workout method is also provided. A portable workout mat is provided. The portable workout mat is unfolded or unrolled onto a floor so that the portable workout mat has a full extension and with the synthetic turf facing upward. A workout routine is performed with at least one glider sliding on the synthetic turf. The portable workout mat is rolled up or folded up for transport after completion of the workout routine.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, similar reference characters denote similar elements throughout the several views.

FIG. 1 shows a perspective view of the workout mat with the synthetic turf side facing upwards.

FIG. 2 shows an enlarged side view of the workout mat with the synthetic turf layer facing upwards.

FIG. 3 shows a view of the workout kit including a rolled-up workout mat and a pair of gliders.

FIG. 4 shows a person performing a workout routine using gliders on a synthetic turf side of the workout mat and the synthetic turf side facing upwards.

FIG. 5 shows a person performing a yoga workout routine with the padding layer side facing upwards and the synthetic turf side facing downwards.

FIG. 6 shows an enlarged overhead view of an edge region of the workout mat with the synthetic turf side facing upwards.

FIG. 7 shows an overhead view of another embodiment of the workout mat with the synthetic turf side facing upwards.

### DETAILED DESCRIPTION OF THE PREFERRED EMBODIMENTS

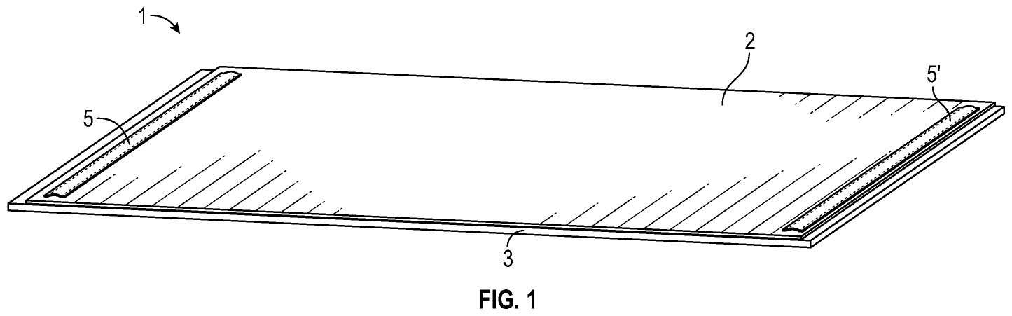

FIG. 1 of the drawings shows a perspective view of a first embodiment of a portable workout mat 1. The mat 1 includes a padding layer 3 that includes a first padding material. The mat 1 also includes a second layer 2 attached to the padding layer 3. The second layer 2 is synthetic turf. In the view shown in FIG. 1, the second layer 2 is facing upwards. The portable workout mat 1 is a strip, e.g. a rectangular strip, that is configured to be rolled out or unfolded for a workout by an individual exerciser with either the padding layer 3 facing upward or the second layer 2 facing upward. The strip is configured to be rolled up or folded up for removal and transport after completion of the workout.

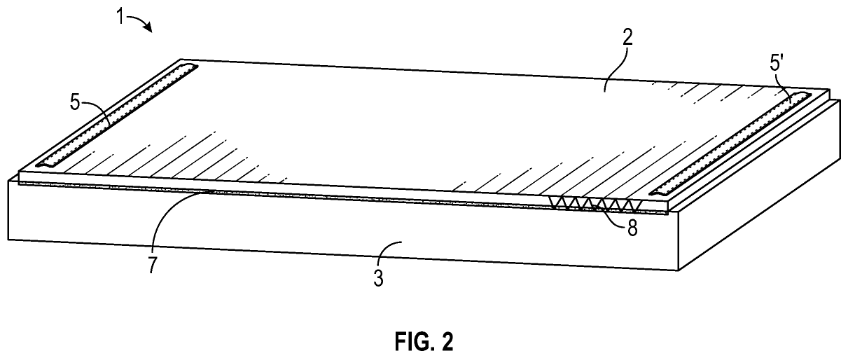

FIG. 2 shows an enlarged side view of the workout mat 1 with the synthetic turf layer 2 facing upwards. The ledge at each longitudinal end of the synthetic turf layer 2 shown in FIGS. 1 and 2 is due to drawing disproportions and in practice will have a smooth transition between the end of the synthetic turf layer 2 at each end as the workout mat 1 flows into the padding material 3.

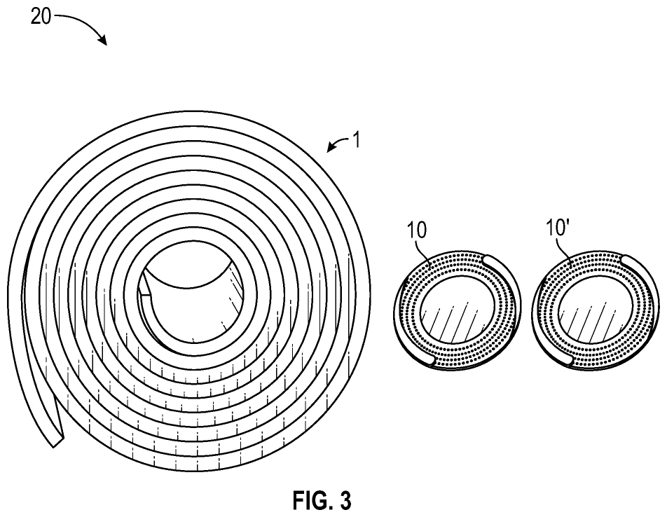

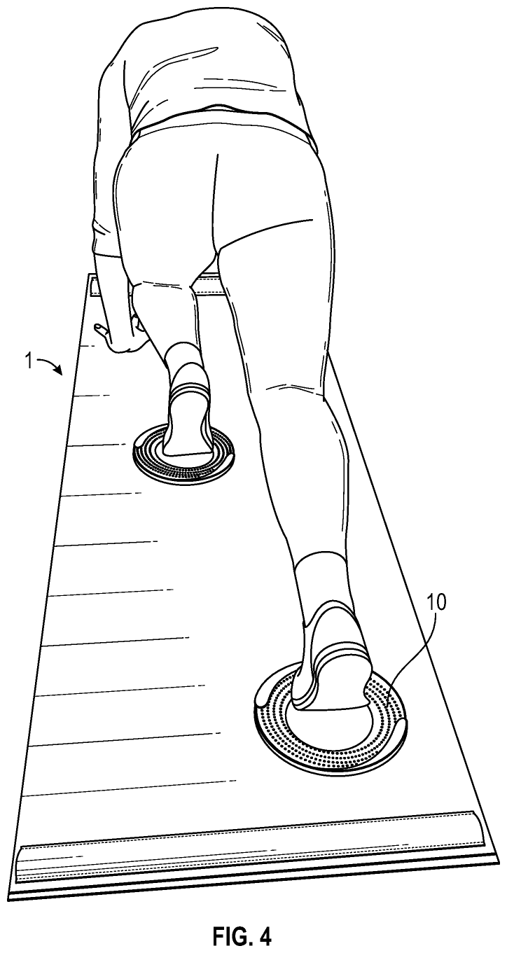

Because the workout mat 1 can be easily transported and set out for a workout and then removed when the workout is finished, the athlete or exerciser can receive the benefits of a turf or carpet field workout at any location. A glider 10 shown in FIGS. 3 and 4 can slide along the synthetic turf side of the workout mat 1. Therefore, the mat 1 can be used not only at gyms and in club classes at clubs or gyms, but also at home, even in a garage or in an unfinished basement. The workout mat 1 can be taken by travelers for a workout in a hotel room. Schools can use the mats for physical education for students.

Workouts with gliders 10, 10′ can produce great, high-intensity, calorie burns. Workouts performed with glider discs 10, 10′ force the exerciser to use the core muscles to perform the workouts. Lunges, squats, planks, climbers, plank, jacks, and push-ups are all examples of exercises that can be enhanced with the use of gliders 10, 10′, and, therefore, with the use of the portable workout mat 1.

When the gliders 10, 10′ are used during a workout, the core of the exerciser is challenged so that stability can be maintained, which makes the workout extra challenging. For example, when performing fifty climbers on a regular floor the athlete will raise his or her heart rate, will achieve a good cardio workout, and will improve his or her strength. The same workout of fifty climbers when done with the gliders, however, will challenge the athlete in maintaining his or her balance and, therefore, will force him or her to use his or her core to achieve stability. Therefore, a cardio blast workout can also be transformed into a core workout that helps develop upper body strength.

Because the workout mat 1 is portable, an athlete or exerciser can take the mat 1 and wash or sanitize the workout mat 1 or at least store the workout mat 1 in a secure environment. By controlling the usage of the mat 1, the exerciser can maintain hygienic or sanitary control of the mat 1. Big carpets that are used at the gym will capture and hold dirt and sweat from the gym-goers and are less sanitary. Cleaning a large turf area is difficult, with the club being hot and a huge number of different people visiting and sweating all over the ground each day. The floors at the gym become infested with germs, mold, and mildew.

The workout mat 1 can make a small space or a wood floor or a tile floor into a glider-suitable workout area. Gyms are often brought about in accommodations where space is a concern, and many gyms do not have room to install a permanent large turf field.

The first padding material may be composed of at least one material selected from the group consisting of latex, rubber, jute, and PVC vinyl. The first padding material is resistant to wear and tear and can be antibacterial. The first padding material could be an eco-friendly material which contains natural rubber and no synthetic rubber. The first padding material could be covered with a microfiber suede surface and could include designs on the open surface of the material. It is traditionally understood that yoga mats are not slippery.

The synthetic turf which will allow the gliders to glide may include nylon fibers and/or polypropylene fibers and/or polyester fibers and/or wool fibers and may be carpet or carpet-like, for example like the artificial playing surface for a football field. The turf side will be mildew and water resistant. The presence of the synthetic turf makes the overall workout mat 1 thicker, so that even when a regular yoga workout is done with the synthetic turf facing down, the workout mat 1 is thicker so that more cushioning is available to the exerciser performing yoga or other exercise activities. This cushion is helpful when ab workouts are performed on the yoga mat side. The cushioning is helpful, because many exercisers experience pain in the lower back and knees. Usually a low pile synthetic turf will be chosen in order to enhance the ability for the gliders to glide or slide. Longer pile synthetic turfs could also be used, but will not allow the gliders to glide or slide as well.

Additional layers of material or different padding could be connected to the first padding material, but the synthetic turf will always be an outer layer of the workout mat 1. The yoga mat side of the workout mat 1 will usually not be slippery.

The portable workout mat 1 may further include a stopper 5, 5′ attached to the second layer 2 at an end region of the second layer 2. For example as shown in FIGS. 1, 2, 4, 5, and 7, one stopper 5 may be disposed at a first longitudinal end region of the mat 1 and a second stopper 5′ may be disposed at a second longitudinal end region, opposite from the first longitudinal end region, of the workout mat 1.

The stopper 5, 5′ is formed of a different material than the synthetic turf and with a material that is harder than the synthetic turf. For example, the stopper 5, 5′ may be formed of latex or some other hard plastic such as acrylic, polycarbonate, semicrystalline polyethylene terephthalate (PET), nylon, polystyrene, other thermoplastics, acetal, resin impregnated in thick canvas, glass reinforced thermoset polyester, glass/expoxy composite, polybutylene terephthalate (PBT), etc. The stopper 5, 5′ may include a plurality of protrusions 13 that protrude above a surface region of the stopper 5, 5′ and that are configured to produce friction against a floor or against a glider 10, 10′. FIG. 6 shows with an enlarged view an example of this embodiment of the portable workout mat 1 having the stopper 5 with the protrusions 13. The latex stopper 5 may be a stopper strip, e.g. a rectangular strip, and may extend along a width of the portable workout mat 1. The stopper strip has a central bulge 17 that extends laterally and protrudes upwards away from the synthetic turf. Underneath the central bulge 17 is an air cavity 19 between the stopper 5 and the synthetic turf. The air cavity 19 runs along the width of the portable workout mat 1 underneath the central bulge 17. On each side of the central bulge 17, the stopper strip adheres flatly against the synthetic turf with two flat regions 18, 18′. The stopper strip may be attached to the synthetic turf and optionally also to the padding layer 3 via a stitching seam 15 that runs laterally along the stopper strip, i.e. in the width direction of the mat 1 but in the length direction of the stopper strip. The stopper strip may include multiple stitching seams 15, for example a stitching seam 15 on each side of the central bulge 17. The stopper 5 will adhere flatly against the synthetic turf in the region at and near the stitching seam 15. The stitching seams 15 will be within the flat regions 18 and 18′. The bulge 17 could be one-sixteenth of an inch or one-eighth of an inch, or one quarter of an inch, or half an inch or another distance above or below these amounts.

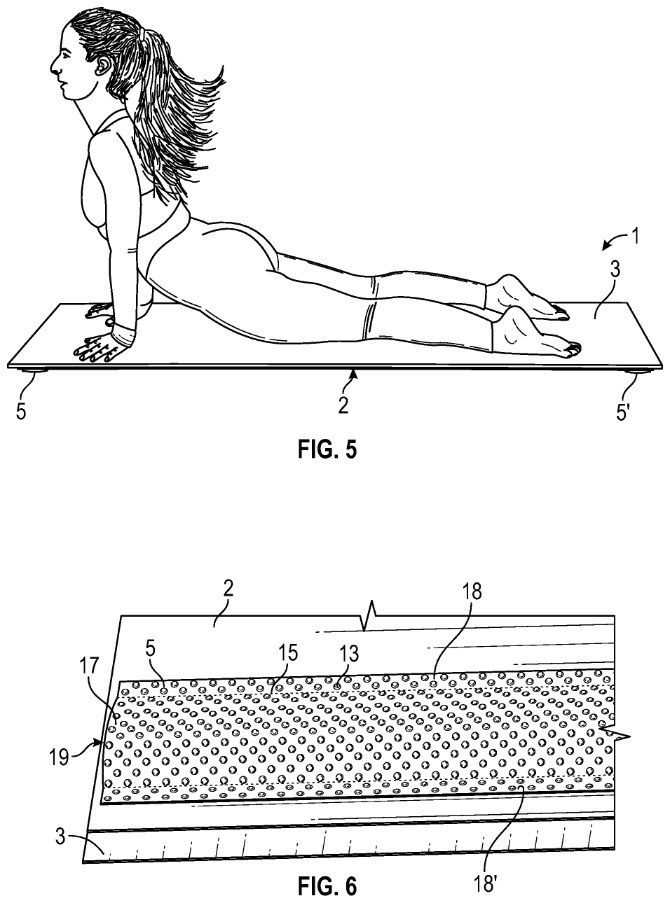

FIG. 4 shows a person performing an exercise routine while using the gliders 10, e.g. a mountain climber exercise. The stoppers 5, 5′ can prevent the gliders 10 from sliding off the edge of the workout mat 1. When the mat 1 is placed with the padding layer 3 facing upwards as is shown for example in FIG. 5, the stoppers 5, 5′ at the longitudinal ends of the mat 1 face and contact the ground and produce friction. The friction prevents the mat 1 from sliding which could be a problem when the synthetic turf directly contacts the ground. Therefore, the stoppers 5, 5′ also provide greater stability for a workout when the yoga mat side of the workout mat 1 faces upward and the person directly contacts the padding layer 3.

The portable workout mat 1 may have a length and a width smaller than the length. The drawings show a workout mat 1 with a width smaller than the length.

The portable workout mat 1 may have a customized size. Several portable workout mats 1 can be laid out adjacent to each other so that a larger turf workout area can be created. A weighted sled could then be pulled over the larger turf workout area. The weighted sled can be pulled smoothly over the larger turf workout area where the mats are connected end to end.

The portable workout mat 1 may have a rectangular shape as is shown in the drawings.

The portable workout mat 1 in one embodiment may have the second layer 2 stitched to the padding layer 3. For example, in the embodiment shown in FIG. 2 a stitching 8 is used to attach the second layer 2 to the padding layer 3. The stitching may be at certain regions alone or may spread throughout an entire periphery of the workout mat 1 to firmly secure the second layer 2 to the padding layer 3. The stitching may also be used in interior regions to secure the second layer 2 to the padding layer 3.

The portable workout mat 1 in one embodiment may additionally or alternatively include adhesive 7 to adhere the second layer 2 to the padding layer 3. For example, in the embodiment shown in FIG. 2 a layer of adhesive 7 is also provided to adhere the second layer 2 to the padding layer 3. This layer of adhesive 7 could be disposed at edge regions only of the synthetic turf. Adhesive could additionally be disposed in interior regions of the synthetic turf in order to provide a greater adherence of the second layer 2 to the padding layer 3.

The portable workout mat 1 may have a width of between 2 feet and 3 feet. The mat could have a width of 2 feet or less or 2.1 feet or 2.2 feet or 2.3 feet or 2.4 feet or 2.5 feet or 2.6 feet or 2.7 feet or 2.8 feet or 2.9 feet or 3.0 feet or greater or any amount or range between these.

The portable workout mat 1 may have a length of between 3.5 feet and 10 feet. The mat could have a length of 3.5 feet or less or 3.6 feet or 3.7 feet or 3.8 feet or 3.9 feet or 4.0 feet or 4.1 feet or 4.2 feet or 4.3 feet or 4.4 feet or 4.4 feet or 4.5 feet or 4.6 feet or 4.7 feet or 4.8 feet or 4.9 feet or 5.0 feet or 5.1 feet or 5.2 feet or 5.3 feet or 5.4 feet or 5.5 feet or 5.6 feet or 5.7 feet or 5. 8 feet or 5.9 feet or 6.0 feet or 6.1 feet or 6.2 feet or 6.3 feet or 6.4 feet or 6.5 feet or 6.6 feet or 6.7 feet or 6.8 feet or 6.9 feet or 7.0 feet or7.1 feet or 7.2 feet or 7.3 feet or 7.4 feet or 7.5 feet or 7.6 feet or 7.7 feet or 7.8 feet or 7.9 feet or 8.0 feet or 8.1 feet or 8.2 feet or 8.3 feet or 8.4 feet or 8.5 feet or 8.6 feet or 8.7 feet or 8.8 feet or 8.9 feet or 9.0 feet or 9.1 feet or 9.2 feet or 9.3 feet or 9.4 feet or 9.5 feet or 9.6 feet or 9.7 feet or 9.8 feet or 9.9 feet or 10.0 feet or greater or any amount or range between these.

The portable workout mat 1 may in one embodiment have a thickness for the padding layer of between 0.30 inches and 0.0625 inches. The portable workout mat 1 could have a thickness of 0.25 inches or 0.20 inches or 0.15 inches or 0.10 inches or 0.05 inches or any amount or range between these.

The stopper 5, 5′ may in one embodiment have a rectangular shape, for example as is shown in FIGS. 1 and 2. The stopper may have a length of 18 inches and a width of 2 inches. The edge of the stopper may in one embodiment be about 1 and ⅜ inches from the edge of the synthetic turf layer which itself is about 1 and ⅜ inches from the edge of the overall workout mat 1. The stoppers 5, 5′ may be completely disposed within the last ten percent of the overall length of the workout mat 1, or within the last nine percent of the overall length of the workout mat 1, or within the last eight percent of the overall length of the workout mat 1, or within the last seven percent of the overall length of the workout mat 1, or within the last six percent of the overall length of the workout mat 1, or within the last five percent of the overall length of the workout mat 1. The region between the stoppers 5, 5′ on the opposite longitudinal ends of the mat 1 is preferably made exclusively of the synthetic turf (with perhaps small strips (1 and ⅜ inches or less) of the padding material on the lateral edge regions) and without any stopper in that region. The stoppers may also have other shapes besides a rectangular shape. The stoppers may be formed from multiple smaller stopper regions distributed separated from each other along the width of the workout mat 1, instead of the single unified stoppers 5, 5′ that extend along the width of the workout mat 1.

A workout kit 20 may include a portable workout mat 1 as described in the various embodiments and may also include one or more gliders 10, 10′. FIG. 3 shows an example of the workout kit 20 that includes a workout mat 1 (shown in a rolled-up state) and two gliders 10, 10. Each glider 10, 10′ has a gliding surface and is configured to hold a foot or a hand and is configured to slide along the synthetic turf of the portable workout mat 1.

In one embodiment, the glider 10, 10′ of the workout kit includes a curved hard plastic surface that constitutes the gliding surface.

In one embodiment, the glider may further include a concave surface disposed opposite from the gliding surface.

The glider could be formed of other materials besides a hard plastic or in addition to a hard plastic.

The workout mat 1 may be easily rolled up or folded up and transported with a user anywhere they go. A carry strap can be slipped over the shoulder to let the shoulder hold the light weight of the mat 1.

A workout method may include steps of (1) providing a portable workout mat 1 as described, (2) unrolling or unfolding the portable workout mat 1 onto a floor so that the portable workout mat 1 has a full extension and with the synthetic turf of the second layer 2 facing upward, (3) performing a workout routine with at least one glider 10, 10′ sliding on the synthetic turf of the second layer 2; and (4) rolling or folding up the portable workout mat 1 for transport after completion of the workout routine. FIG. 4 of the drawings shows a person performing a workout routine using gliders 10, 10′ to glide or slide along the synthetic turf of the second layer 2 of the workout mat 1.

In a further embodiment, the method may additionally include steps of (1) placing the portable workout mat 1 with the padding layer 3 facing upward; and (2) performing a workout with an individual exerciser directly contacting the padding layer 3. FIG. 5 of the drawings shows a person performing a yoga workout routine while the person lies on the padding material 3 of the workout mat 1, with the synthetic turf of the second layer 2 facing downward. For this exercise, the stoppers 5, 5′ at the opposite ends of the synthetic turf produce friction against the floor to prevent the workout mat 1 from sliding while the person performs the yoga workout while touching the padding material 3.

Various exercises can be performed with the gliders on the synthetic turf of the second layer 2 of the portable workout mat 1.

For the mountain climber exercise, the feet are on the gliders 10, 10′ while the body is held in a raised arm plank. The arms of the exerciser are extended. The shoulders are lined up above the hands. One knee is brought in towards the chest as the glider slides up the turf. The knees are then switched so that the other knee is brought in towards the chest while the first knee slides back. Legs are alternated quickly.

For a knee tuck exercise with the workout kit 20, the exerciser is in the raised arm plank position. The feet are on the gliders 10, 10′ on the mat 1. Both knees are brought into the chest together sliding on the gliders along the mat 1, and then the knees are slid back and returned to the starting plank position.

For a pike-to-plank exercise, the feet are on the gliders in a raised arm plank. The core of the exerciser is lifted up as the feet glide, and the body forms a pike shape. The pike shape is released and the exerciser returns body to the plank position.

For a turf saw exercise, the exerciser is in a forearm plank position with the forearms down flat on the mat. The shoulders are lined up with the elbows. The toes of the exerciser are on the gliders. Then the hands are placed flat on the mat. The exerciser rocks forward and backward, using the core muscles with each shift.

For a turf alligator exercise, in a raised arm plank the arms of the exerciser are extended with the feet on the gliders on the mat 1. The exerciser walks forward on the hands until the torso is longitudinally past the mat, all while the plank is maintained. Then the exerciser walks the hands back in the opposite longitudinal direction.

For a turf burpee exercise, the feet are on the gliders and in a raised arm plank. The exerciser sweeps both knees forward into the chest and the exerciser jumps up into the standing position while the feet stay on the gliders. Then the exerciser comes back down to the mat and places hands on the mat, while the feet glide back to a raised arm plank position.

For a turf ankle extension exercise, the exerciser is on the mat in a forearm plank position and with the feet on the gliders. The toes are extended outwards while only the toes and not the heel remains on the gliders, and while the upper body remains in a forearm plank position. Then return to a starting plank.

For a turf-cycle exercise, the exerciser takes an upright sit-up pose on the mat with the heels of the feet on the gliders. One knee is extended to the opposite elbow, with the glider gliding along the turf. Then the other knee is switched positions with the first knee, all while keeping the feet on the gliders. The exerciser keeps his or her eyes up.

For a raised arm turf bridge switcher exercise, the exerciser takes a raised arm position with the arms extended and the exerciser in a glute bridge position. Heels of both feet are on a respective glider. While keeping the buttocks or core region of the exerciser up and off of the mat, the exerciser extends one foot forward and then alternates feet. Tricep dips at rest can optionally be added in.

For a turf ab reach exercise, while lying on the right side with a glider in one hand, the exerciser lets the glider lead him or her out to the end of the mat 1. The exerciser uses the core muscles to stabilize. The exerciser then returns to the starting side lying position. Then he or she can switch to work the left side.

For a turf lateral swoop exercise, the exerciser stands on the turf side of the mat 1 facing the lateral side of the mat and has the right foot on the glider. The other foot is directly on the turf on the mat 1 and is part of the stable leg. The stable leg has a slight bend using a glider to move the foot out into a circular motion stopping at a star point. The move is repeated, and then the exerciser can switch sides and feet assignments.

For a turf angel exercise, the exerciser lies back down on the mat with the heels each in a glider and with the feet and arms fully extended. The exerciser swoops the arms forwards in rounding the body while lifting the shoulders off of the mat. Using the gliders on the feet, the exerciser brings the knees in. The exerciser returns to the starting back-down laying position, and then repeats.

For a turf crunch exercise, the exerciser lies backdown on the turf on the mat with the knees bent upwards and the feet are flat on the mat. The palms of the hands lie on the gliders. The exerciser then lifts the shoulders off of the mat 1 while the hands are extended forward on the gliders. This movement works the upper abs. Then the exerciser returns to the starting backdown and knees-up position.

For a turf pushup exercise, the exerciser performs a pushup with the hands on the gliders on the mat 1. During the push upwards, the hands glide on the gliders inward along the turf of the mat 1. Then during the body lowering in preparation for the next push up, the hands glide on the gliders outward on the mat 1. Because of the rectangular design of many of the mats, for this exercise the exerciser will often have feet off of the mat and the body aligned perpendicularly to the longitudinal direction of the mat 1.

For a side lunge exercise, the exerciser stands on the mat 1 and has one foot on the glider on the mat 1 and the other foot directly on the mat 1. The exerciser faces perpendicularly to the longitudinal direction of the mat 1. The exerciser extends the foot on the glider out while the stable leg stays forward and bends with a lunge. The exerciser returns to a starting position and then repeats.

For a turf windshield wiper exercise, in a plank position and with the feet on gliders on the mat 1 and with the body aligned perpendicular to a longitudinal direction of the mat, the hands are off of the mat. The hands hold the body in a plank position while one leg glides out and then is swept back in. The leg glide and return is then repeated for the other side.

For a turf pushup core teeter exercise, the exerciser kneels on the mat 1 and has the hands laying palms down on the gliders. The exerciser is facing the longitudinal direction of the mat 1. The exerciser brings his or her hips forward as both hands glide forward. The exerciser fully extends the right arm forward as the left arm stays back. Then the right arm is glided back into the body. The exerciser returns to a starting position. Each time for the forward thrust, the exerciser switches whether the right or the left arm will be extended fully forward.

For a turf core extender exercise, the exerciser kneels down with the hands on the gliders on the turf. The exerciser is facing the longitudinal direction of the mat 1. The exerciser extends the hips forwards as the hands glide on gliders forward along the turf. The hands glide in unison forwards and reach out together. The exerciser then returns to the starting position. This return forces him or her to use abdominal muscles for the return.

For a second turf crunch exercise, the exerciser lays back down on the mat with the legs lifted so that the thighs are at a ninety degree angle to the mat 1 and the lower leg then is parallel to the mat 1. The arms are flat on the mat, with the palm of each hand facing down in a glider. The leg positioning is held as the exerciser lifts his or her shoulders forward, which causes the hands to slide forward on the gliders. The exerciser returns to a starting position and then repeats.

For a turf skier exercise, the exerciser stands on the mat 1 with both feet on a respective glider. The feet are slid forward and backwards, with one foot being forward while the other is backward. The legs are slid quickly forward and back, without forming a deep knee lunge. This exercise is a faster pace cardio move.

For a turf plank jack exercise, the exerciser is in a plank position over the mat 1, with the body aligned perpendicular to a longitudinal direction of the mat 1. The feet are on gliders. The hands are on ground off of the mat 1. The feet are close, but then glide outward away from each other while the upper body is maintained in the plank position. Then the legs are brought back in. These movements are repeated.

For a turf skater exercise, the exerciser stands on the mat 1 and faces to be aligned perpendicular to a longitudinal direction of the mat 1. Both feet are on the gliders. One foot maintains its position while the other foot glides outward. The glided foot then glides back to a central position, and then the other foot glides outward. This exercise is intended to be a fast paced cardio move.

For a beginner turf glute bridge switch exercise, the exerciser lies back down on the mat, but with the feet flat on gliders on the mat 1. In the starting position, the lower legs point upward from the mat 1. The exerciser has the arms extended out and keeps the shoulders down on the mat 1. The exerciser lifts the core/buttocks up off the floor and holds the position as a glute bridge. Then with the feet flat and knees bent, one foot is slid forward and then back. Then other foot is slid forward and back.

For a turf squats alternate exercise, the exerciser stands on the mat 1 and is facing a perpendicular direction with respect to a longitudinal direction of the mat 1. Both feet are on a respective glider on the mat 1. The user glides one foot out while the body is in a squatting position. Then that foot glides back in and the other foot is glided out while the body maintains the squatting position.

For a turf hamstrings slides exercise, the exerciser lies on a mat 1 with the feet on a respective glider. The knees are bent with the core/buttocks up in a glute bridge position. Both feet are glided forward together, so the body approaches a horizontal position, and then the feet are glided back in to the knee-bend position. The glides are repeated.

For a forward lunge exercise, the exerciser stands on the mat 1 with a glider under one foot. The other foot is directly on the mat 1. The foot on the glider is lunged forward, while the knee of the other leg is bent. Then when the exerciser glides the foot back to normal vertical position, the movement forces the core muscles to work. Both legs are brought together, and then the move is repeated. Gliding foot can be switched so that both sides will be worked.

For a one legged fast switch lunge exercise, the exerciser stands on the mat 1 with one leg on a glider and the other foot directly on the mat 1. With the core held tight and with the shoulders back, the glider is glided back and then glided back in swiftly. The movements are repeated and the exerciser returns to a starting position.

For a reverse lunge exercise, with a glider on one foot and with the exerciser standing on a mat 1, the foot on the glider glides backwards with the other foot remaining stationary until the knee of the stationary foot is bent at a ninety degree angle.

These exercises are examples to be performed using the synthetic turf on the second layer 2 of the portable workout mat 1 or the workout kit 20. Other exercises can be performed as well using the workout mat 1.

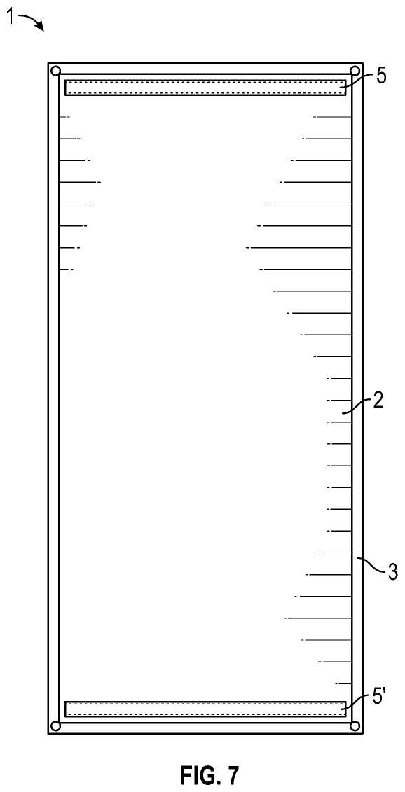

FIG. 7 shows another embodiment of the portable workout mat 1. In this embodiment, the synthetic turf of the second layer 2 has a shorter width than the padding material 3 has. Therefore, in the overhead view shown in FIG. 7 it appears that the padding material 3 forms a frame around the synthetic turf of the second layer 2. This embodiment also includes grommets, e.g. circular grommets, disposed in the four corners of the workout mat 1 to facilitate carrying the mat 1. When the padding material 3 has a different color than the synthetic turf of the second layer 2 has, then with this embodiment a favorable color distinction or color popping can be provided from the overhead view.

What is claimed is:

1. A portable workout mat comprising:
a padding layer comprising a first padding material; and
a second layer attached to the padding layer, the second layer comprising synthetic turf;
wherein the portable workout mat is a strip configured to be rolled out or unfolded for a workout by an individual exerciser with either the padding layer facing upward or the second layer facing upward; and
wherein the strip is configured to be rolled up or folded up for removal and transport after completion of the workout.

2. The portable workout mat as claimed in claim 1, wherein the first padding material comprises at least one member selected from the group consisting of latex, rubber, jute, and PVC vinyl.

3. The portable workout mat as claimed in claim 1, wherein the synthetic turf comprises at least one fiber selected from the group consisting of nylon, polypropylene, polyester, and wool.

4. The portable workout mat as claimed in claim 1, further comprising a stopper attached to the second layer at an end region of the second layer, the stopper being formed of material different from the synthetic turf.

5. The portable workout mat as claimed in claim 4, wherein the stopper comprises a plurality of protrusions protruding above a surface region, the protrusions being configured to produce friction against a floor or against a glider.

6. The portable workout mat as claimed in claim 4, wherein the stopper is a stopper strip and extends along a width of the portable workout mat,
wherein the stopper strip has a central bulge extending laterally and protruding away from the synthetic turf, and
wherein on each side of the central protrusion, the stopper strip adheres flatly against the synthetic turf.

7. The portable workout mat as claimed in claim 1, wherein the portable workout mat has a length and a width smaller than the length.

8. The portable workout mat as claimed in claim 1, wherein the portable workout mat has a rectangular shape.

9. The portable workout mat as claimed in claim 1, wherein the second layer is stitched to the padding layer.

10. The portable workout mat as claimed in claim 1, wherein the second layer is adhered to the padding layer via an adhesive.

11. The portable workout mat as claimed in claim 1, wherein the mat has a width of between 2 feet and 3 feet.

12. The portable workout mat as claimed in claim 1, wherein the mat has a length of between 3.5 feet and 10 feet.

13. The portable workout mat as claimed in claim 1, wherein the padding layer has a thickness of between 0.25 inches and 0.0625 inches.

14. A workout kit comprising:
a portable workout mat as claimed in claim 1; and
at least one glider having a gliding surface and configured to hold a foot or a hand of a person who is working out, the at least one glider being configured to slide along the synthetic turf of the portable workout mat.

15. The workout kit as claimed in claim 14, wherein a curved hard plastic surface of the at least one glider constitutes the gliding surface, and
wherein the at least one glider further comprises a concave surface disposed opposite from the gliding surface.

16. A workout method comprising:
providing a portable workout mat as claimed in claim 1;
unrolling or unfolding the portable workout mat onto a floor so that the portable workout mat has a full extension and with the synthetic turf facing upward;
performing a workout routine with at least one glider sliding on the synthetic turf; and
rolling or folding up the portable workout mat for transport after completion of the workout routine.

17. The workout method as claimed in claim 16 and further comprising:
placing the portable workout mat with the padding layer facing upward; and
performing a workout with an individual exerciser directly contacting the padding layer.
